(19) United States
(12) Patent Application Publication
(10) Pub. No.: US 2012/0192543 A1
(43) Pub. Date: Aug. 2, 2012

(54) EXHAUST NOZZLE FOR A BYPASS AIRPLANE TURBOJET HAVING A DEPLOYABLE SECONDARY COVER AND A RETRACTABLE CENTRAL BODY

(75) Inventors: Sébastien Jean-Paul Aeberli, Paris (FR); Guillaume Bodard, Verneuil I' Etang (FR); Alexandre Alfred Gaston Vuillemin, Fontainebleau (FR)

(73) Assignee: SNECMA, Paris (FR)

(21) Appl. No.: 13/362,826

(22) Filed: Jan. 31, 2012

(30) Foreign Application Priority Data
Feb. 1, 2011 (FR) 11 50769

(51) Int. Cl. F02K 3/02

(52) U.S. Cl. 60/204; 60/226.1

(57) ABSTRACT

The invention relates to an exhaust nozzle for a bypass airplane turbojet comprising an annular central body, an annular primary cover surrounding the central body to define a hot stream flow channel, and an annular secondary cover surrounding the primary cover to define a cold stream flow channel, each of the central body and the secondary cover comprising a stationary portion and a movable portion connected to a downstream end of the stationary portion, the movable portion of the central body being suitable for being retracted longitudinally upstream relative to the stationary portion, and the movable portion of the secondary cover being suitable for being deployed longitudinally downstream relative to the stationary portion.

### BACKGROUND OF THE INVENTION

The present invention relates to the general field of treating the noise emitted by bypass airplane turbojets.

An exhaust nozzle for a bypass airplane turbojet generally comprises an annular central body, an annular primary cover arranged concentrically around the central body and co-operating therewith to define an annular flow channel for passing a hot stream from the turbojet, and an annular secondary cover arranged concentrically around the primary cover and co-operating therewith to define an annular flow channel for a cold stream, known as a “bypass” stream.

The present trend for reducing jet noise from such a turbojet during airplane takeoff and approach stages is to increase its bypass ratio (i.e. the ratio of the mass of air in the cold stream to the mass of air in the hot stream), in particular by increasing the flow section of the cold stream flow channel. For equal thrust, increasing the bypass ratio of the turbojet serves to reduce the exhaust speeds and thus the noise due to the exhaust gases mixing.

Nevertheless, increasing the bypass ratio of a bypass turbojet gives rise to an increase in its outside diameter, thereby leading to a manifest problem of accommodating engines under the wings of an airplane. At present, the reasonable limit on the size of a bypass turbojet suitable for being accommodated under a wing has in practice already been reached, and it would appear to be difficult to continue any further in this direction.

In order to reduce the jet noise of a bypass turbojet, it is also known to provide one of the covers of the exhaust nozzle with a plurality of repetitive patterns (e.g. of triangular shape) that are distributed all around the circumference of the trailing edge of the cover in question (generally the primary cover). Putting such patterns into place encourages mixing between the streams at the outlet from the nozzle, thereby contributing to reducing jet noise.

Although that technique is found to be quite effective, it nevertheless presents a negative impact on the aerodynamic performance of the turbojet during stages of cruising flight. In addition, the improvements obtained in terms of noise reduction remain relatively modest.

### OBJECT AND SUMMARY OF THE INVENTION

A main object of the present invention is thus to mitigate such drawbacks by proposing a different approach for reducing the jet noise from a nozzle of an airplane turbojet of the bypass type.

This object is achieved by an exhaust nozzle for a bypass airplane turbojet comprising an annular central body, an annular primary cover surrounding the central body to define a hot stream flow channel, and an annular secondary cover surrounding the primary cover to define a cold stream flow channel, wherein each of the central body and the secondary cover comprises a stationary portion and a movable portion connected to a downstream end of the stationary portion, the movable portion of the central body being suitable for being retracted longitudinally upstream relative to the stationary portion, and the movable portion of the secondary cover being suitable for being deployed longitudinally downstream relative to the stationary portion.

During takeoff and approach stages, the movable portion of the secondary cover of such a nozzle is deployed downstream (relative to a nominal position of the nozzle), while the movable portion of the central body is retracted upstream relative to the nominal position of the nozzle. In this configuration, the nozzle then comes close to being a nozzle of the type for passing a confluence of two streams. This type of nozzle enhances mixing between the cold stream and the hot stream, thereby contributing to reducing jet noise. Furthermore, and still in this configuration, lengthening the secondary cover makes it possible to confine the sources of noise coming from the fan and to mix the cold and hot streams together. As a result there is a high level of acoustic attenuation of jet noise on takeoff and during the approach stage of the airplane.

During stages of cruising flight, the movable portion of the secondary cover is retracted upstream in order to return it to its nominal position, while the movable portion of the central body is deployed downstream in order to return it to its nominal position. In this configuration, the nozzle returns to being a bypass type nozzle that enhances drag reduction, thereby contributing to reducing the specific consumption of the airplane.

As a result, the nozzle of the invention serves to reduce jet noise during takeoff and approach stages without thereby penalizing aerodynamic performance during cruising flight stages. In particular, on cycles involving equivalent performance on takeoff (in particular in terms of thrust), the improvement provided by such a nozzle is 2 EPNdB (“effective perceived noise in decibels”), which is to be compared with an improvement lying in the range 0.5 EPNdB to 1 EPNdB for a nozzle in which the trailing edge of the primary cover is fitted with triangular jet noise reduction patterns.

Advantageously, the inside surface of the secondary cover is coated at least in its movable portion with a passive noise-treatment coating. Thus, lengthening the secondary cover enables these noise sources to be treated more effectively because of the presence of such acoustic treatment.

Also advantageously, the movable portion of the central body is suitable for retracting upstream relative to the stationary portion through a distance dl satisfying the following inequality:

0<d1≦D₂₆

where D₂₆ is the outside diameter of the hot stream flow channel.

Still advantageously, the movable portion of the secondary cover is suitable for deploying downstream relative to the stationary portion through a distance d2 satisfying the following inequality:

0<d2≦D₂₄

where D₂₄ is the outside diameter of the cold stream flow channel.

The movable portion of the secondary cover may be suitable for deploying under the drive of at least one actuator having its cylinder fastened to the stationary portion and its rod fastened to the movable portion. Similarly, the movable portion of the central body may be suitable for retracting under the drive of at least one actuator having its cylinder fastened to the stationary portion and its rod fastened to the movable portion.

The invention also provides a bypass airplane turbojet including an exhaust nozzle as defined above.

The invention also provides a method of controlling an exhaust nozzle as defined above, the method consisting: during airplane takeoff and approach stages, in deploying the movable portion of the secondary cover downstream relative to a nominal position and in retracting the movable portion of the central body upstream relative to a nominal position; and during a cruising flight stage, in retracting the movable portion of the secondary cover upstream in order to return it to its nominal position and in deploying the movable portion of the central body downstream in order to return it to its nominal position.

### BRIEF DESCRIPTION OF THE DRAWINGS

Other characteristics and advantages of the present invention appear from the following description made with reference to the accompanying drawings that show an embodiment having no limiting character. In the figures:

FIG. 1 is a diagrammatic section view of an airplane bypass turbojet having a nozzle of the invention, the nozzle being shown in its cruising flight configuration; and

FIG. 2 is a view of the FIG. 1 turbojet with the nozzle put into a takeoff configuration.

### DETAILED DESCRIPTION OF AN EMBODIMENT

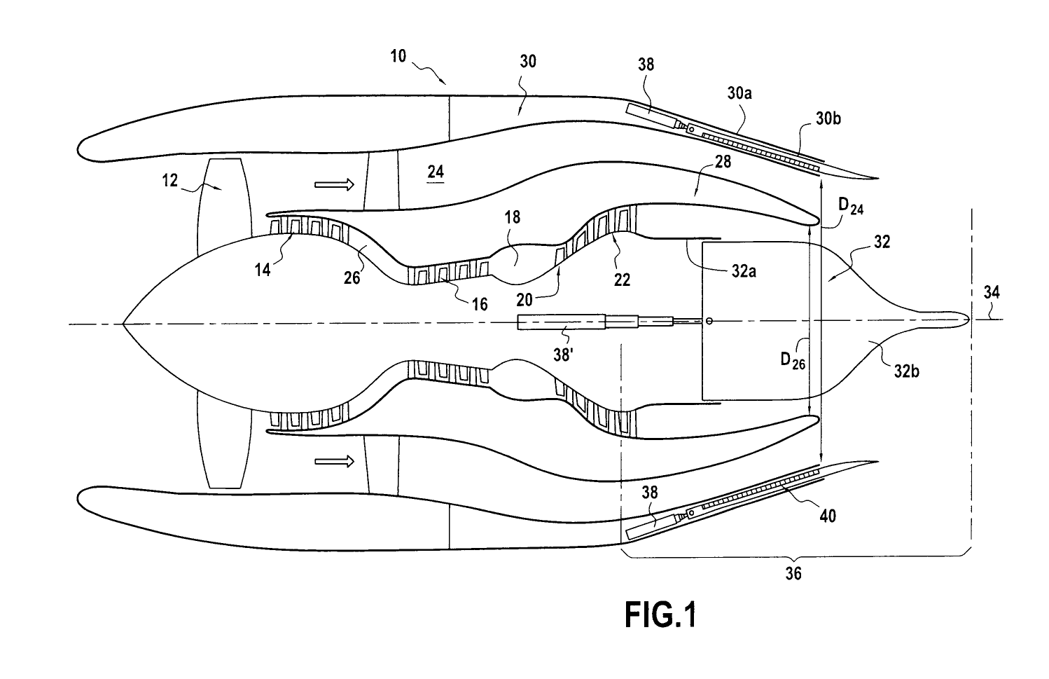

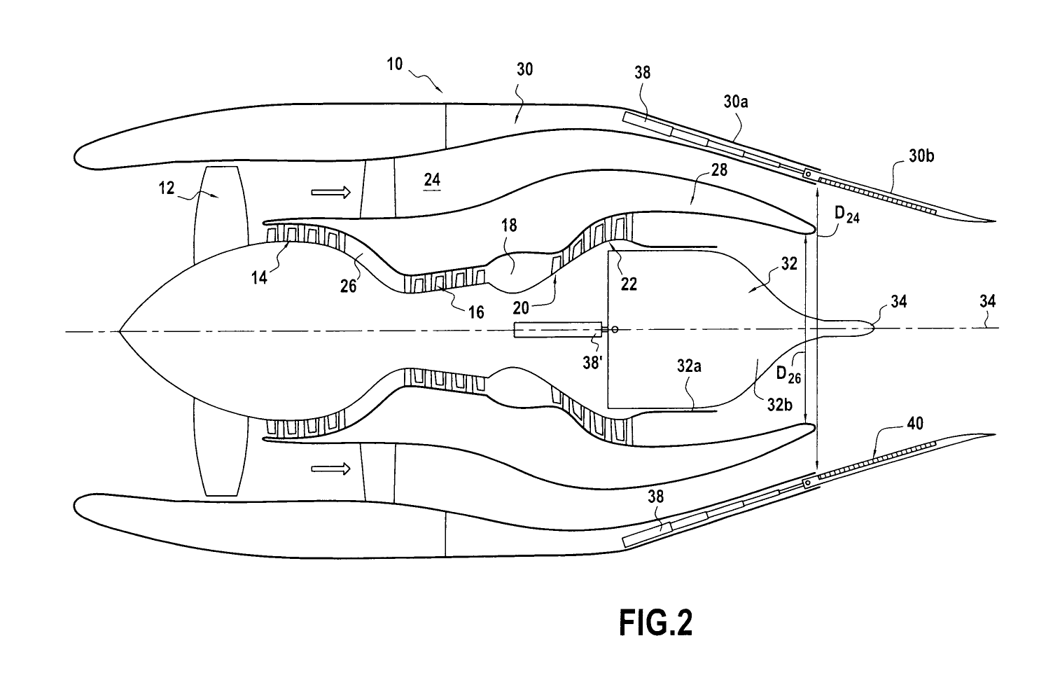

The invention applies to any bypass type airplane turbojet such as that shown in FIGS. 1 and 2.

In known manner, a bypass airplane turbojet 10 comprises, from upstream to downstream: a fan 12, a low pressure compressor 14, a high pressure compressor 16, a combustion chamber 18, a high pressure turbine 20, and a low pressure turbine 22.

The fan delivers a stream of air that is fed firstly to an annular cold stream flow channel 24 and secondly to an annular hot stream flow channel 26 that is coaxial with the cold stream flow channel.

The cold stream flow channel 24 is defined radially between an annular primary cover 28 (on the inside) and an annular secondary cover 30 (on the outside) arranged concentrically around the primary cover and formed in particular by the nacelle of the turbojet. The hot stream flow channel 26 is defined radially between the primary cover 28 (on the outside) and the annular central body 22 of the turbojet (on the inside).

The central body and the primary and secondary covers of the turbojet are centered on the longitudinal axis 34 of the turbojet, and they present an axially-symmetrical shape about said axis. The terminal portions of these elements form a nozzle 36 for ejecting the gas streams coming from the turbojet.

According to the invention, the shape of the nozzle 36 is variable depending on the state of flight of the airplane. During stages of cruising flight (FIG. 1), the nozzle has a “nominal” position in which it presents a shape that is conventional for a nozzle of the type passing two separate streams. This configuration gives preference to reducing drag, thereby contributing to reducing the specific consumption of the airplane. In contrast, during takeoff and approach stages (FIG. 2), the nozzle presents the shape of a nozzle of the type for passing a confluence of two streams, enhancing mixing between the cold stream and the hot stream, thereby contributing to reducing jet noise.

For this purpose, the central body 32 of the nozzle comprises a stationary portion 32a and a movable portion 32b connected to a downstream end of the stationary portion, the movable portion of the central body being suitable for retracting longitudinally upstream relative to the stationary portion.

Similarly, the secondary cover 30 of the nozzle has a stationary portion 30a and a movable portion 30b connected to a downstream end of the stationary portion, the movable portion of the stationary cover being suitable for being deployed longitudinally downstream relative to the stationary portion.

More precisely, the movements of the movable portions 30b and 32b of the secondary cover and of the central body respectively and relative to the corresponding stationary portions 30a and 30b are driven by one or more actuators, given respective references 38 and 38′, each having a cylinder fastened to the corresponding stationary portion and a rod fastened to the corresponding movable portion.

It should be observed that in the embodiment of FIGS. 1 and 2, the movable portions move inside the corresponding stationary portions. An inverse arrangement could naturally also be envisaged.

Furthermore, and advantageously, the movable portion 32b of the central body 32 is capable of retracting upstream relative to the stationary portion 32a over a distance dl that satisfies the following inequality:

0<d1≦D₂₆

where D₂₆ is the outside diameter of the hot stream flow channel 26. It should be observed that the outside diameter D₂₆ that is taken into consideration is the diameter measured at the end of the hot stream channel defined by the downstream end of the primary cover 28.

Still advantageously, the movable portion 30b of the secondary cover 30 may be deployed downstream relative to the stationary portion 30a over a distance d2 that satisfies the following inequality:

0<d2≦D₂₄

where D₂₄ is the outside diameter of the cold stream flow channel 24. It should be observed that the outside diameter D₂₄ that is taken into consideration is the diameter measured at the downstream end of the cold stream channel 24 as defined by the downstream end of the linkage portion 30a of the secondary cover 30.

By way of example, for a turbojet having a large bypass ratio with the outside diameter D₂₄ of its cold stream flow channel measuring 2 meters (m), the movable portion of the secondary cover may be deployed over a longitudinal distance that may be as much as 2 m.

During cruising flight stages (FIG. 1), the movable portion 32b of the central body 32 of the nozzle is held in its position deployed downstream relative to the stationary portion 32a, and the movable portion 30b of the secondary cover 30 is held retracted upstream relative to the stationary portion 30a. The nozzle is thus in its “nominal” configuration with a short nacelle that limits drag so as to reduce the specific consumption of the airplane.

During takeoff and approach stages (FIG. 2), the movable portion 32b of the central body 32 of the nozzle is retracted upstream relative to its nominal position, and the movable portion 30b of the secondary cover 30 is deployed downstream relative to its nominal position. The nozzle is thus in its configuration of the type for passing two confluent streams, thereby enhancing mixing between the hot stream and the cold stream, thereby contributing to reducing jet noise.

Furthermore, at least the movable portion 30b of the secondary cover of the nozzle presents a passive noise-treatment coating 40 on its inside surface, e.g. in the form of a honeycomb structure operating on the principle of Helmholtz resonators.

Thus, when the movable portion 30b of the secondary cover 30 is deployed downstream relative to its nominal position, the noise from the turbojet fan may be treated acoustically over a greater length (generally passive noise treatment panels are also arranged on the inside surface of the secondary cover downstream from the fan and upstream from the nozzle). In this configuration of the nozzle, the lengthening of the secondary cover serves firstly to confine the noise sources coming from the fan and the mixing between the cold and hot streams, and secondly to treat these noise sources more effectively by the presence of the acoustic treatment.

What is claimed is:

1. An exhaust nozzle for a bypass airplane turbojet comprising an annular central body, an annular primary cover surrounding the central body to define a hot stream flow channel, and an annular secondary cover surrounding the primary cover to define a cold stream flow channel, wherein each of the central body and the secondary cover comprises a stationary portion and a movable portion connected to a downstream end of the stationary portion, the movable portion of the central body being suitable for being retracted longitudinally upstream relative to the stationary portion, and the movable portion of the secondary cover being suitable for being deployed longitudinally downstream relative to the stationary portion.

2. A nozzle according to claim 1, wherein the inside surface of the secondary cover is coated at least in its movable portion with a passive noise-treatment coating.

3. A nozzle according to claim 1, wherein the movable portion of the central body is suitable for retracting upstream relative to the stationary portion through a distance dl satisfying the following inequality:
0<d1≦D₂₆
where D₂₆ is the outside diameter of the hot stream flow channel.

4. A nozzle according to claim 1, wherein the movable portion of the secondary cover is suitable for deploying downstream relative to the stationary portion through a distance d2 satisfying the following inequality:
0<d2≦D₂₄
where D₂₄ is the outside diameter of the cold stream flow channel.

5. A nozzle according to claim 1, wherein the movable portion of the secondary cover is suitable for deploying under the drive of at least one actuator having its cylinder fastened to the stationary portion and its rod fastened to the movable portion.

6. A nozzle according to claim 1, wherein the movable portion of the central body is suitable for retracting under the drive of at least one actuator having its cylinder fastened to the stationary portion and its rod fastened to the movable portion.

7. A bypass airplane turbojet including an exhaust nozzle according to claim 1.

8. A method of controlling an exhaust nozzle according to claim 1, the method consisting:
during airplane takeoff and approach stages, in deploying the movable portion of the secondary cover downstream relative to a nominal position and in retracting the movable portion of the central body upstream relative to a nominal position; and
during a cruising flight stage, in retracting the movable portion of the secondary cover upstream in order to return it to its nominal position and in deploying the movable portion of the central body downstream in order to return it to its nominal position.
